(19) United States
(12) Patent Application Publication
(10) Pub. No.: US 2006/0012302 A1
(43) Pub. Date: Jan. 19, 2006

(54) Plasma display panel

(75) Inventors: Wen-Fa Sung, Hsinchu City (TW); Yao-Ching Su, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/054,632

(22) Filed: Feb. 9, 2005

(30) Foreign Application Priority Data
Jul. 15, 2004 (TW) 93121120

(51) Int. Cl. H01J 17/49

(52) U.S. Cl. 313/582

(57) ABSTRACT

A plasma display panel. A rear substrate is opposite a front substrate. A rib structure is formed on the rear substrate, defining a plurality of sub-pixel regions, wherein the rib structure comprises a first portion extending substantially in a first direction and a second portion extending substantially in a second direction. A sustain electrode is formed on the front substrate, wherein the sustain electrode comprises a bus electrode covering the first portion of the rib structure and a plurality of protrusions covering a potion of the second portion of the rib structure.

### BACKGROUND OF THE INVENTION

1. Field of the Invention

The present invention relates to a plasma display panel (PDP) and, more particularly, to bus electrodes and rib structures of a plasma display panel.

2. Description of the Related Art

A plasma display panel (PDP) is a thin type display, typically has a large display area. The luminescent principle of the PDP is the same as that of fluorescent lamps. A vacuum glass trough is filled with inert gas. When a voltage is applied to the glass trough, plasma occurs and radiates ultraviolet (UV) rays. The fluorescent material coated on the wall of the glass trough adsorb the UV rays, hence the fluorescent material radiates visible light including red, green and blue light. A plasma display can be described as a combination of hundreds of thousands of illuminating units, each illuminating unit has three subunits for radiating red, green and blue light, respectively. Images are displayed by mixing these three primary colors.

As shown in FIG. 1, a conventional PDP 10 has a pair of glass substrates 12, and 14 arranged parallel and opposite to each other. A discharge space 16 is formed between the glass substrates 12, and 14 and injected with inert gases, such as Ar, Xe or others. The upper glass substrate 12 has a plurality of transverse electrode group positioned in parallel. Each group of transverse electrode groups has a first and a second sustaining electrode 18, and 20, and each of which includes transparent electrodes 181, 201 and bus electrodes 182, 202. A dielectric layer 24 is further formed to cover these transverse electrodes, and a protection layer 26 is formed on the dielectric layer 24.

The lower glass substrate 14 has a plurality of barrier ribs 28 arranged in parallel and spaced apart by a predetermined distance dividing the discharge space 16 into a plurality of groups of sub-discharge spaces. Each group of sub-discharge spaces includes a red discharge space 16R, a green discharge space 16G, and a blue discharge space 16B. Additionally, the lower glass substrate 14 has a plurality of lengthwise electrodes 22 disposed in parallel between two adjacent barrier ribs 28 serving as address electrodes. In addition, a red fluorescent layer 29R, a green fluorescent layer 29G, and a blue fluorescent layer 29B are respectively coated on the lower glass substrate 14 and the sidewalls of the barrier ribs 28 within each red discharge space 16R, each green discharge space 16G, and each blue discharge space 16B.

When a voltage is applied for driving these electrodes, the inert gases in the discharge space 16 are discharged to produce UV rays. The UV rays further illuminate the fluorescent layers 29R, 29G, 29B to radiate visible light including red, green and blue light. After the three primary colors are mixed at different ratios, various images are formed and transmitted through the upper glass substrate 12.

FIG. 2 is a plane view of a conventional PDP with close sub-pixel spaces. As shown in FIG. 2, bus electrodes 202 are disposed on a front substrate, extending along the profile of ribs 204 substantially in direction X to prevent them from blocking a light source of the PDP. Typically, the ribs 204 are white, such that ambient light is easily reflected by the uncovered white ribs 206, thus reducing contrast of the PDP.

### SUMMARY OF THE INVENTION

An embodiment of the invention provides a bus electrode with protrusions to cover ribs on a rear substrate, thus reducing reflection of ambient light and increasing contrast of PDP.

To achieve the above objects, the present invention provides a high contrast plasma display structure. A plurality of ribs are formed on a rear substrate to define a plurality of sub-pixel spaces, wherein the ribs comprise first portions extending substantially in a first direction and second portions extending substantially in a second direction perpendicular to the first direction. A front substrate is disposed opposite to the rear substrate. A sustain electrode formed on the front substrate comprises a bus electrode and a plurality of protrusions. The bus electrode extends substantially along the first portion. The protrusions extend along the second portion from the bus electrode, covering the second portion without connecting to adjacent bus electrodes.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the structure of the conventional PDP.

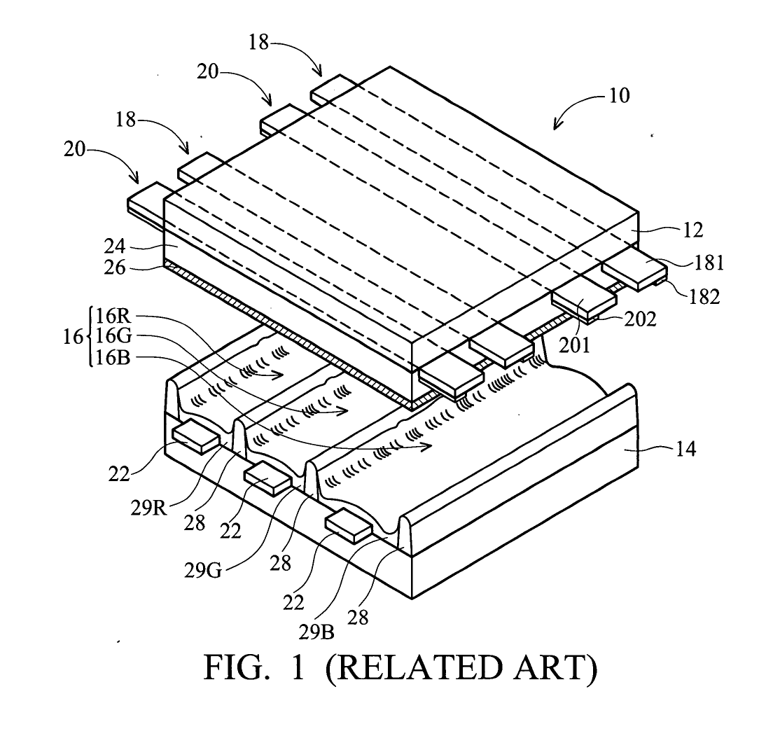

FIG. 2 is a plane view of the conventional PDP with close sub-pixel spaces;

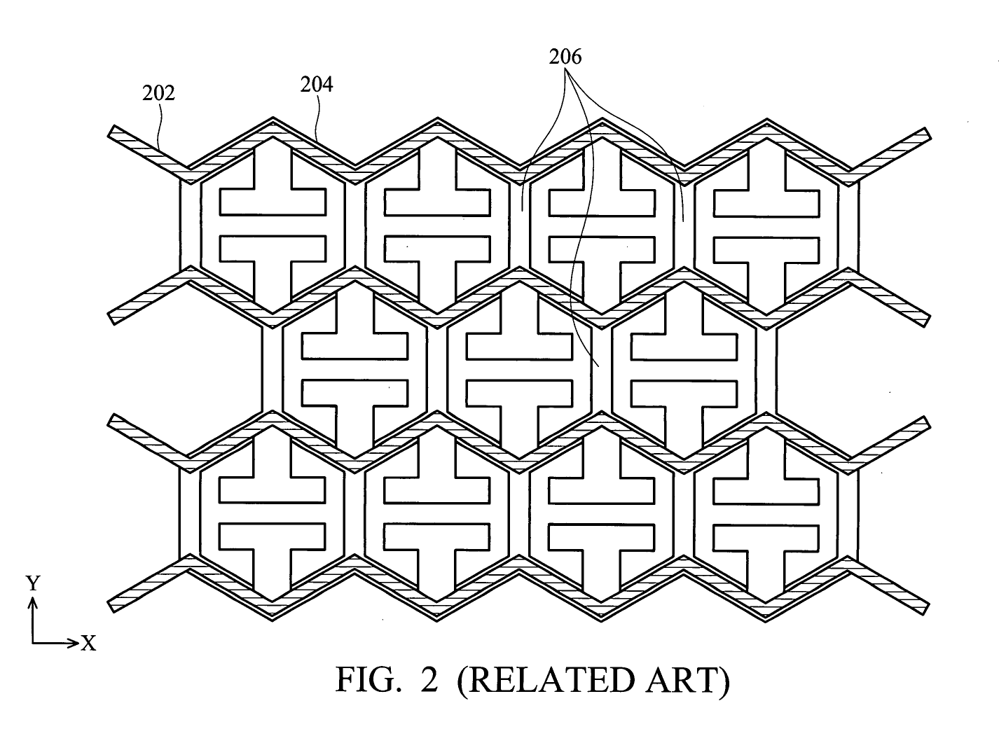

FIG. 3 is a plane view of PDP of the first embodiment;

FIG. 4 is a plane view of a PDP of the second embodiment;

FIG. 5 is a plane view of a PDP of the third embodiment;

FIG. 6 is a plane view of a PDP of the fourth embodiment;

FIG. 7 is a plane view of a PDP of the fifth embodiment.

### DETAILED DESCRIPTION OF THE INVENTION

An embodiment of the invention provides a sustain electrode structure formed on a front substrate for covering ribs. The sustain rib structure comprises a bus electrode and protrusions extending thereof. The bus electrode is along ribs thereunder and extends in a direction. The exposed ribs are further covered by the protrusions.

Embodiments with various ribs and corresponding sustain electrode structures will be described in the following, but the invention is not limited thereto.

Examples with rectangular discharge spaces arranged triangularly and corresponding sustain electrode structures are illustrated in the first embodiment. Examples in the second embodiment have similar rib structures with the first embodiment, but the sustain electrode structures differ. The third embodiment illustrates rectangular discharge spaces arranged in a matrix, and corresponding sustain electrode structures. The fourth embodiment illustrates hexagonal discharge spaces arranged triangularly, and corresponding sustain electrode structures. The fifth embodiment illustrates saw-shaped ribs extending along direction Y. The saw-shaped ribs form hexagonal discharge spaces, and further with dark regions.

### FIRST EMBODIMENT

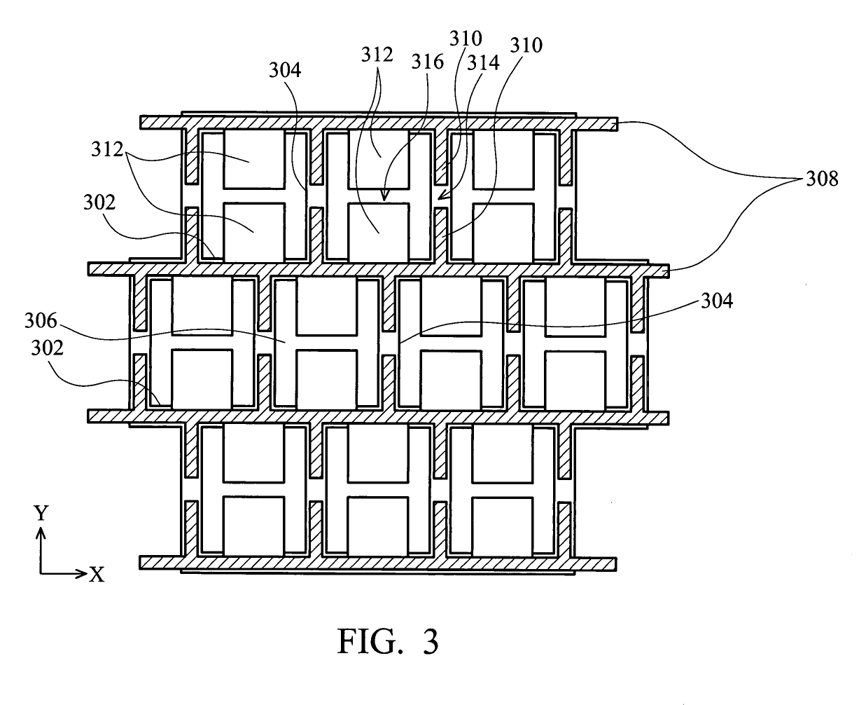

FIG. 3 is a plane view of a PDP of the first embodiment. As illustrated in FIG. 3, a rib structure formed on a rear substrate includes first portions 302 and second portions 304. The first portions 302 are arranged in parallel and the second portions 304 in parallel to perpendicularly intersect the first portions 302, thereby defining rectangular sub-pixel spaces 306. The rectangular sub-pixel spaces 306 are arranged triangularly. In the preferred embodiment, the first portions 302 extend along direction X and the second portions 304 along direction Y. Address electrodes (not shown) are formed under sub-pixel spaces 306 and the second portions 304. The ribs 304 and 306 are formed by depositing thick film on the rear substrate, followed by sandblasting and sintering process. The preferable thickness of the ribs 304 and 306 is about 120˜150 μm. Red, green and blue phosphor layers are respectively disposed on the rectangular sub-pixel spaces 306 in a delta configuration, thus forming delta color pixels.

A plurality of sustain electrodes are formed on the front substrate opposite the rear substrate, and cover the ribs 302 and 304 on the rear substrate. Each of the sustain electrode comprises a bus electrode 308 extending along the first portions 302 and a plurality of protrusions 310 extending along the second portions 304. Thus, the second portions 304 along the direction Y are covered by the protrusions 310. The bus electrodes 308 are preferably formed of non-transparent materials 308, such as Cr, Cu, Ag or their combination. Consequently, the white ribs 302 and 304 are covered by the non-transparent bus electrodes 308 and protrusions 310. The electrodes comprise metal having low resistance.

The bus electrodes 308 and the protrusions 310 can be formed with the same process step, such as depositing and patterning a metal layer. Consequently, additional process steps are not required. Wing portions 312 extending from corresponding bus electrodes 308 respectively protrude out and toward the phosphor-coated sub-pixel spaces 306. Preferably, wing portions are formed of transparent materials, such as ITO, to increase light emission.

Adjacent protrusions 310 along a second rib 304 are separated by a predetermined distance, for example 70 μm, to prevent crosstalk. Preferably, the first gap 314 between two adjacent protrusions 310 in the Y direction is large than the second gap 316 between two adjacent wing portions 312 to avoid arcing, and the width of the protrusions 310 is 0.7˜1.2 times that of the second portions 304, such that the second portions 304 can be covered by protrusions to reduce reflection of ambient light.

Because the protrusions 310 are preferably formed at the same time as the bus electrodes, addition process steps, such as photo lithography and etching, are not required for forming protrusions 310. Additionally, because the bus electrodes 308 and the protrusions 310 are formed of non-transparent materials, the first portions 302 covered by the bus electrodes 308 and the second portions 304 covered by the protrusions 310 cannot reflect ambient light. Specifically, the second portions 304 on the rear substrate are covered by the protrusion 310 to reduce reflection of ambient light and increase contrast of PDP.

### SECOND EMBODIMENT

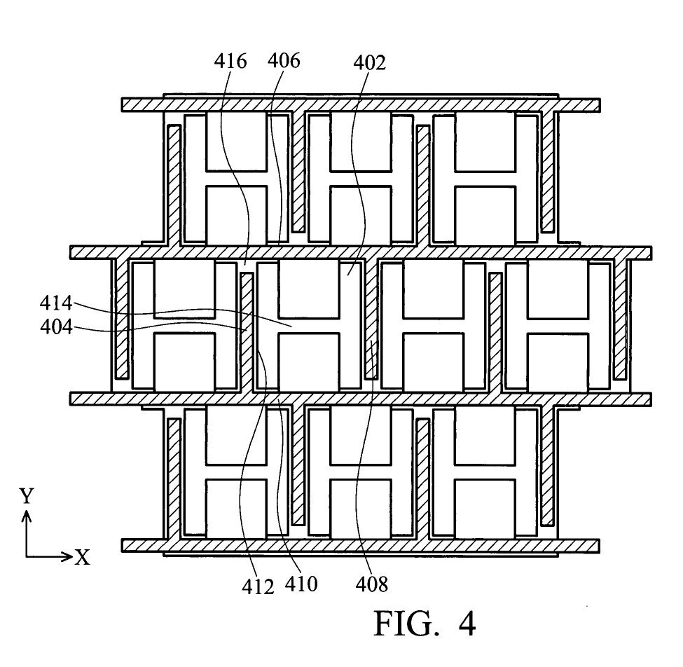

FIG. 4 is a plane view of a PDP of the second embodiment. Referring to FIG. 4, the rib structure and the bus electrodes are the same as in the first embodiment, only the structure of the protrusions 402 differs.

In this embodiment, a protrusion 404 extends from a bus electrode 410 in a direction Y, covering a second portion 408 of the rib structure, and the adjacent protrusion 408 extends from the opposite electrode 406. The second portions 412 of the rib structure on the rear substrate are also covered by the protrusion 404 and 408 that reflection of ambient light is eliminated and contrast of PDP is increased.

Alternatively, the bus electrodes comprise a first bus electrode 410 and a second bus electrode 406. The protrusions comprise a first protrusion 404 and a second protrusion 408. The first protrusion 404 is connected to the first bus electrode 410. The second protrusion 408 is connected to the second bus electrode 406. The first protrusion 404 is separated from the second bus electrode 406, and the second protrusion 408 is separated from the first bus electrode 410.

In the embodiment, because the third gap 416 between the protrusion 404 and the opposite bus electrode 406 is spaced apart from the discharge region 414, the third gap 416 can be smaller than the first gap 314 in FIG. 3 of the first embodiment without arcing problem. The advantage of the embodiment is the third gap 416 is far enough from the discharge region 414 that arcing and cross talk do not easily occur.

### THIRD EMBODIMENT

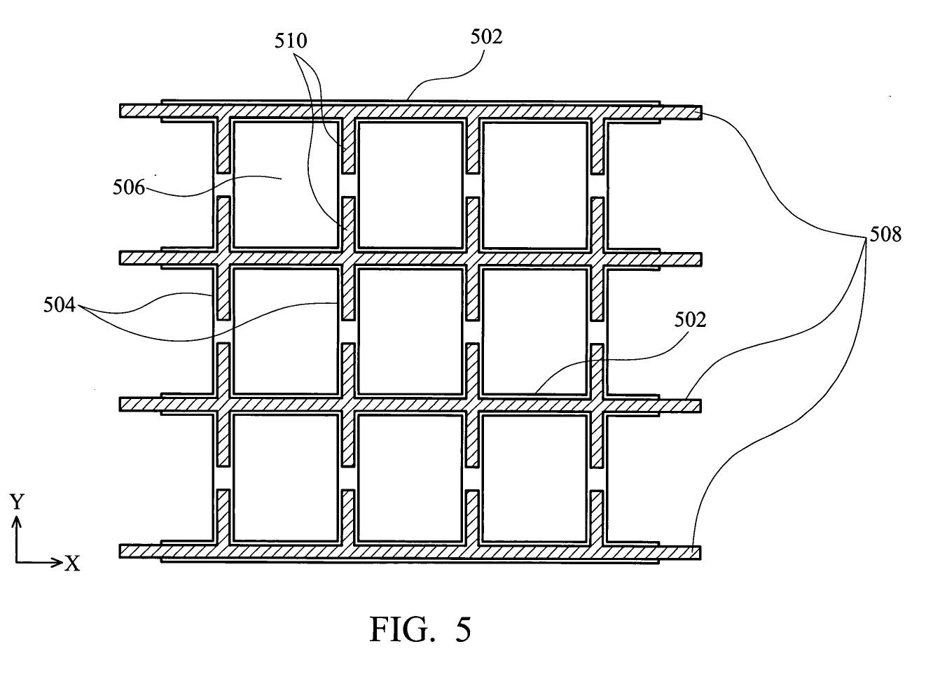

As shown in FIG. 5, a rib structure includes first portions 502 and second portions 504. The PDP of this embodiment comprises a rear substrate formed with first portions 502 arranged in parallel, second portions 504 arranged in parallel perpendicularly intersecting the first portions 502, thereby defining rectangular sub-pixel spaces 506 arranged in a matrix.

A plurality of bus electrodes 508, preferably formed of non-transparent material, such as Cr, Cu, Ag or their combination, are disposed on the front substrate. Each extends along the first portions 502 and has protrusions 510 extended along the second portions 504 from the bus electrodes 508 to cover the second portions 504 on the rear substrate. Accordingly, the white, first and second portions 502, and 504 arranged in a matrix are covered by the non-transparent bus electrodes 508 and protrusions 510, reducing reflection of ambient light.

### FOURTH EMBODIMENT

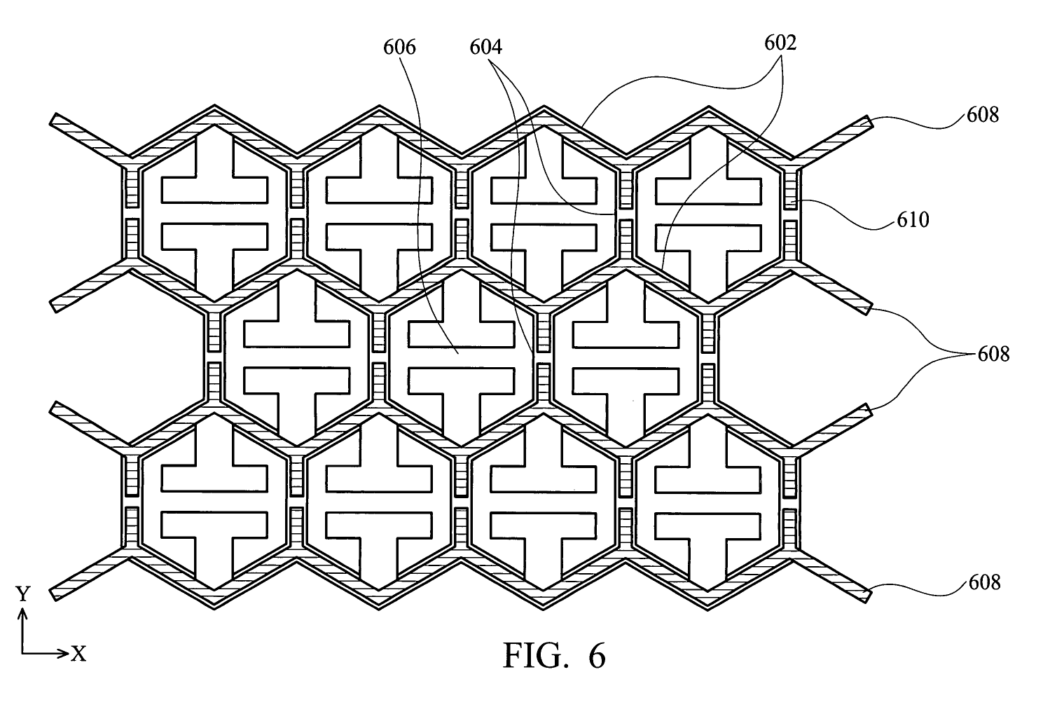

As shown in FIG. 6, a rib structure includes first portions 602 and second portions 604. In this embodiment, a PDP comprises a rear substrate formed with first portions 602 arranged in a zigzag shape, second portions 604 arranged in parallel intersecting the first portions 602, thereby defining hexagonal sub-pixel spaces 606 arranged in a delta configuration.

A plurality of bus electrodes 608, preferably formed of non-transparent materials, such as Cr, Cu, Ag or their combination, are disposed on a front substrate. Each bus electrode 608 extends along the first portions 610 also in a zigzag shape to avoid covering light emitted from discharge space 606. The bus electrodes are formed with protrusions 610 extending along the second portions 604, covering the second portions 604 on the rear substrate. Accordingly, the white, first and second portions 602 and 604 arranging hexagonal sub-pixel spaces 606 are covered by the non-transparent bus electrodes 608 and protrusions 610, reducing reflection of ambient light. In more detail, the zigzag-shaped first portions 602 are covered by the bus electrodes 608, and the second portions 604 by the protrusions 610.

### FIFTH EMBODIMENT

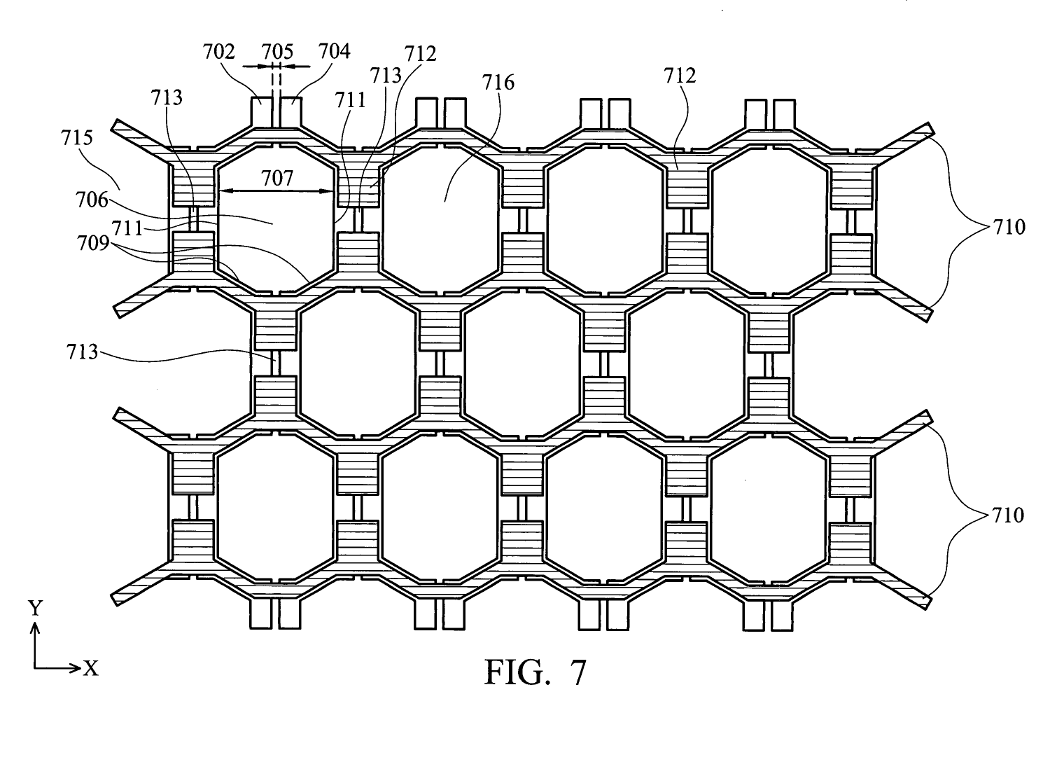

As shown in FIG. 7, a plurality of ribs 702 are formed on the rear substrate and extend substantially in a direction Y. Adjacent ribs 704 spaced apart by corresponding channels define respective sub-pixel spaces and dark regions. The ribs 702 and 704 have a zigzag configuration such that each channel, between adjacent ribs 702 and 704, varies periodically in width in a direction Y between first width 705 and second width 707 becoming respectively smaller than and at least as large as a width required for supporting discharges. The sub-pixel spaces 706 are of the second width 707 and the dark regions 713 are of the first width 705, wherein the second width 707 is larger than the first width 705. For each pixel, the ribs comprise a first portion 709 along X direction and a second portion 711 along Y direction.

A plurality of sustain electrodes are formed on a front substrate opposite a rear substrate, covering the ribs on the rear substrate. The sustain electrodes comprise a plurality of bus electrodes 710 and protrusions 712. The bus electrodes cover the first portions 709 of the rib structure and extend substantially in the direction X. The protrusions 712 cover the second portions 711 of the rib structure and extend substantially in the direction Y. The first portions 709 of the ribs 702 and 704 are covered by the bus electrodes 710. The second portions 711 of the rib structure extending along the direction Y are covered by the protrusions 712.

Additionally, each bus electrode 710 contains protrusions 712 extending in a direction Y from the corresponding bus electrodes 710 to cover the adjacent second portions 711 and the dark regions 713 therebetween. Each dark region 713 is defined by the second portions of the sub-pixel 706 and the one of neighboring sub-pixels 716. The dark regions 713 and the second portions 711 of the rib structure on the both sides are covered by the protrusions 712.

According to embodiments of the invention described, the white ribs are covered by bus electrodes and further with protrusions on the front substrate to eliminate light reflection, thus increasing contrast of the PDP.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

What is claimed is:

1. A plasma display panel, comprises:
a front substrate;
a rear substrate opposite the front substrate;
a rib structure formed on the rear substrate, defining a plurality of sub-pixel regions, wherein the rib structure comprises first portions extending substantially in a first direction and second portions extending substantially in a second direction; and
a sustain electrode formed on the front substrate, wherein the sustain electrode comprises a bus electrode covering the first portion of the rib structure and a plurality of protrusions covering a potion of the second portion of the rib structure.

2. The plasma display panel as claimed in claim 1, wherein the first direction and the second direction are perpendicular.

3. The plasma display panel as claimed in claim 1, wherein the width of the protrusions is 0.7-1.2 times that of the second portions of the rib structure.

4. The plasma display panel as claimed in claim 1, wherein the sub-pixel is rectangular or hexagonal.

5. The plasma display panel as claimed in claim 1, further comprising a plurality of wing portions formed on the front substrate protruding out toward the corresponding sub-pixels.

6. The plasma display panel as claimed in claim 5, wherein two adjacent protrusions are spaced apart by a gap exceeding that between two adjacent wing portions in the second direction.

7. The plasma display panel as claimed in claim 1, wherein the bus electrodes comprises a first bus electrode and a second bus electrode, the protrusions comprises a first protrusion and a second protrusion, the first protrusion is connected to the first bus electrode, the second protrusion is connected to the second bus electrode, the first protrusion is spaced apart from the second bus electrode, and the second protrusion is spaced apart from the first bus electrode.

8. The plasma display panel as claimed in claim 1, further comprising a dark region defined by adjacent sub-pixels.

9. The plasma display panel as claimed in claim 8, wherein the protrusions cover the dark region and the second portions of the rib structure on the both sides of the dark region.

10. The plasma display panel as claimed in claim 1, wherein the protrusions are formed of a material selected from the group consisting of Cu, Cr and Ag.

11. The plasma display panel as claimed in claim 1, wherein the protrusions are formed by the steps of:
forming a metal layer on the front substrate; and
patterning the metal layer to form the bus electrode and the protrusions.

12. A plasma display panel, comprising:
a rib structure disposed on a rear substrate, defining a plurality of sub-pixels;
a plurality of bus electrodes disposed on a front substrate opposite the rear substrate, wherein the bus electrodes covers a portion of the rib structure; and
a plurality of protrusions disposed on the front substrate covering a portion of the rib structure uncovered by the bus electrodes.

13. The plasma display panel as claimed in claim 12, wherein the width of the protrusions is 0.7-1.2 times that of ribs of the rib structure.

14. The plasma display panel as claimed in claim 12, wherein the sub-pixels are rectangular or hexagonal.

15. The plasma display panel as claimed in claim 12, further comprising a plurality of wing portions formed on the front substrate protruding out toward the corresponding sub-pixels.

16. The plasma display panel as claimed in claim 15, wherein two adjacent protrusions are spaced apart by a gap exceeding than that between two adjacent wing portions in a direction perpendicular to the bus electrodes.

17. The plasma display panel as claimed in claim 12, wherein the protrusions are formed of a material selected from the group consisting of Cu, Cr and Ag.

18. The plasma display panel as claimed in claim 12, wherein the protrusions are formed by the steps of:
forming a metal layer on the front substrate; and
patterning the metal layer to form the bus electrode and the protrusions.
